(19) United States
(12) Patent Application Publication
(10) Pub. No.: US 2024/0309982 A1
(43) Pub. Date: Sep. 19, 2024

(54) SELF-HEALING COMPOSITE WRAP SYSTEMS AND METHODS

(71) Applicant: Saudi Arabian Oil Company, Dhahran (SA)

(72) Inventors: Abderrahim Fakiri, Dhahran (SA); Shaj K. Manjalivalapil, Dhahran (SA)

(21) Appl. No.: 18/182,876

(22) Filed: Mar. 13, 2023

(51) Int. Cl. F16L 55/168; B32B 1/08; B32B 5/02; B32B 5/12; B32B 5/26; B32B 37/24; B32B 38/18; D04H 1/587; D04H 1/74; F16L 55/175

(52) U.S. Cl. CPC F16L 55/1683; B32B 1/08; B32B 5/022; B32B 5/12; B32B 5/266; B32B 37/24; B32B 38/1808; D04H 1/587; D04H 1/74; F16L 55/175; B32B 2038/0076; B32B 2250/20; B32B 2260/023; B32B 2260/046; B32B 2262/16; B32B 2305/076; B32B 2305/20; B32B 2556/00; B32B 2597/00; D10B 2505/00

(57) ABSTRACT

The disclosure relates to systems and methods for self-healing composite wraps. The self-healing composite wraps can be used to repair a defect section in a pipe.

### FIELD

The disclosure relates to systems and methods for self-healing composite wraps. The self-healing composite wraps can be used to repair a defective section in a pipe, structure, and/or process equipment.

### BACKGROUND

Composite wraps can be used to repair defect sections in metal pipes. The matrix of the composite wraps can be brittle, resulting in microscopic crack development due to stresses. The cracks can propagate and induce additional stresses causing debonding at the matrix-fiber interface and/or damage to the matrix of the composite wrap.

### SUMMARY

The disclosure relates to systems and methods for self-healing composite wraps. The self-healing composite wraps can be used to repair a defect section in a pipe (e.g., a metal pipe), such as corrosion, dents, pits and cracks.

The composite wraps include fibers. Each of the fibers has an open space. Some of the open spaces are filled with a matrix material, and some of the open spaces are filled with a hardening agent. When contacted together, the matrix material and the hardening agent can fill and cure microscopic cracks in the matrix. The fibers can be arranged in two dimensions, multilayered in three dimensions, and/or randomly oriented to address axial, transverse, hoop and/or shear stress that can result in tension, compression, shear and/or localized stress on the composite wrap.

The systems and methods can be used to repair a defect section in a pipe in an oil and gas system, such as an oil and gas production system (e.g., a pipe in an oil and gas production system, a surface casing,), an oil and gas transportation system (e.g., a transportation pipeline), an oil and gas processing system (e.g., a pipe in oil and gas processing system) and/or a chemical or process industry. The systems and methods can be applied to a straight and/or bent segment of a pipe, such as an elbow joint, a reducer, or a branch. The systems and methods can also be used on process equipment and structures.

The systems and methods can be relatively inexpensive to manufacture and implement. The systems and methods can increase the lifetime of a composite wrap repair, thereby resulting in reduced costs and time associated with repairs and shutdowns.

In a first aspect, the disclosure provides an article that includes a first composite wrap. The first composite wrap includes a fabric that supports a matrix. The matrix includes a plurality of first fibers and a plurality of second fibers. The plurality of first fibers and the plurality of second fibers are arranged parallel to one another and in an alternating fashion. The first fibers include an inner space including a matrix former. The second fibers include an inner space including a hardening agent. The matrix former and hardening agent are configured to form a solid matrix upon contact.

In some embodiments, the article further includes a second composite wrap atop the first composite wrap. The second composite wrap includes a fabric that supports a matrix which includes a plurality of third fibers and a plurality of fourth fibers. The plurality of third fibers and the plurality of the fourth fibers are arranged parallel to one another and in an alternating fashion. The third fibers include an inner space including the matrix former. The fourth fibers include an inner space including the hardening agent.

In some embodiments, the third and fourth fibers are oriented at an angle of from 2° to 178° relative to the first and second fibers.

In some embodiments, a thickness of the matrix of the first composite wrap is from 1 μm to 10 μm.

In some embodiments, the first and second fibers have a maximum cross-sectional dimension of 5 μm to 1000 μm. In some embodiments, the first and second fibers have a wall thickness of from 1 μm to 5 μm.

In some embodiments, the first and second fibers include polyester, polyester, polyurethane, polyvinylacetate, polysulphone (PSF), polyethersulphone (PES), polyacrylonitrile (PAN), polyvinyl, and/or polyvinylidene fluoride (PVDF).

In some embodiments, the matrix former includes epoxy, vinylester, and/or polyurethane.

In some embodiments, the hardening agent includes a polymercaptan, a polyamide, an amidoamine, an aliphatic amine, a cycloaliphatic amine, an aromatic amine, and/or a phenalkamine.

In a second aspect, the disclosure provides a system, including a pipe and an article according to the disclosure wrapped around a portion of the pipe.

In some embodiments, the article is wrapped at an angle of 1° to 89° relative a longitudinal direction of the pipe.

In some embodiments, the pipe is a component of an oil and gas production system, an oil and gas processing system, an oil and gas storage system, and/or a power plant.

In a third aspect, the disclosure provides a method that includes applying a first composite wrap on a restored section of a pipe. The first composite wrap includes a fabric that supports a matrix. The matrix includes a plurality of first fibers and a plurality of second fibers. The plurality of first fibers and the plurality of second fibers are arranged parallel to one another and in an alternating fashion. The first fibers include an inner space including a matrix former. The second fibers include an inner space including a hardening agent. The matrix former and hardening agent are configured to form a solid matrix upon contact.

In certain embodiments, the method further includes applying a second composite wrap atop the first composite wrap. The second composite wrap includes a fabric that supports a matrix including a plurality of third fibers and a plurality of fourth fibers. The plurality of third fibers and the plurality of the fourth fibers are arranged parallel to one another and in an alternating fashion. The third fibers include an inner space including the matrix former. The fourth fibers include an inner space including the hardening agent.

In certain embodiments, the third and fourth fibers are oriented at an angle of from 2° to 178° relative to the first and second fibers.

In certain embodiments, the first composite wrap is applied at an angle of from 1° to 89° relative to a longitudinal direction of the pipe.

In certain embodiments, the method further includes rupturing at least a portion of the plurality of first and second fibers, releasing at least a portion of the matrix former and hardening agent within the ruptured first and second fibers, and reacting the matrix former and the hardening agent to form a solid matrix within a crack in the matrix.

In certain embodiments, the method further includes, prior to applying the first composite wrap on the restored section of a metal pipe, cleaning a defect section of the metal pipe, disposing a filler material into the defect section to convert the defect section to a restored section, and disposing an adhesive primer onto the restored section.

In certain embodiments, the method further includes, after applying the first composite wrap on the restored section of a metal pipe, applying a shrink wrap to the restored section, perforating the shrink wrap, allowing the matrix to cure, and removing the shrink wrap.

In certain embodiments, the method further includes, prior to applying the first composite wrap, forming the first composite wrap, including applying a first portion of the matrix on the fabric, disposing the first and second fibers on the fabric, and applying a second portion of the matrix on the fabric and the first and second fibers.

In a fourth aspect, the disclosure provides a method that includes forming a composite wrap. Forming the composite wrap includes applying a first portion of a matrix on a fabric, disposing a plurality of first and second fibers on the fabric, and applying a second portion of the matrix on the fabric and plurality of first and second fibers. The plurality of first fibers and second fibers are arranged parallel to one another and in an alternating fashion. The first fibers include an inner space including a matrix former. The second fibers include an inner space including a hardening agent. The matrix former and hardening agent form a solid matrix upon contact.

### BRIEF DESCRIPTION OF THE FIGURES

FIG. 1 depicts a schematic of a composite wrap.

FIG. 2A depicts a plan view of a composite wrap with a crack.

FIG. 2B depicts an expanded view of a portion of the composite wrap and the crack.

FIG. 3 depicts a schematic of an article.

FIGS. 4A-4D depict schematic views of articles prepared during a method for producing a composite wrap.

FIGS. 5A and 5B depict schematics of a repaired pipe FIG. 6 depicts a schematic of an oil and gas system.

FIG. 7 depicts a flowchart for a method of repairing a defect section of a pipe.

### DETAILED DESCRIPTION

### Self-Healing Composite Wraps

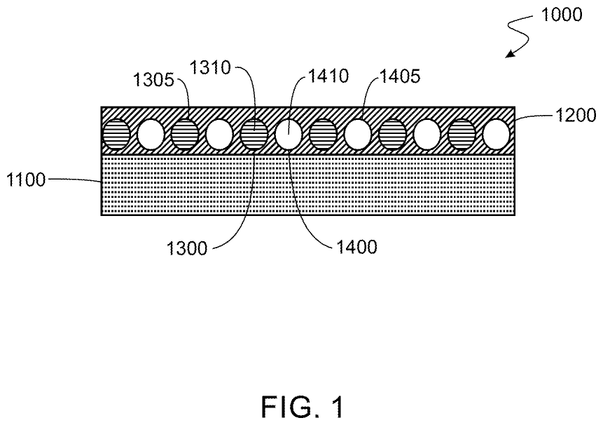

FIG. 1 depicts a composite wrap 1000. The composite wrap includes a fabric 1100 and a matrix 1200 disposed atop the fabric 1100. The fabric may also be impregnated and/or saturated with the matrix 1200. Within the matrix 1200 is a plurality of fibers 1300 having a wall 1305 defining an inner space filled with a matrix former 1310. Also within the matrix 1200 is a plurality of fibers 1400 having a wall 1405 defining an opening filled with a hardening agent 1410. The fibers 1300 and 1400 are arranged parallel to one another and in an alternating fashion. The matrix former 1310 and hardening agent 1410 form a solid matrix upon contact (see discussion below).

The composite wrap 1000 can be used in a composite wrap repair of a defect section of a pipe, such as a pipe in an oil and gas system (see discussion below).

In general, each of the fabric 1100, the matrix 1200, the fibers 1300 and the fibers 1400 can be formed of any appropriate material(s). In some embodiments, the fabric 1100 can include carbon, glass or aramid fibers. In certain embodiments, the matrix 1200 is a polymer matrix that can include epoxy, polyurethane and/or vinylester. In some embodiments, the fibers 1300 and fibers 1400 can include fibers composed of polyester, polyurethane, polyvinylacetate, polysulphone (PSF), polyethersulphone (PES), polyacrylonitrile (PAN), polyvinyl alcohol (e.g., PVC), and/or polyvinylidene fluoride (PVDF). In certain embodiments, the fibers 1300 are formed of the same material as the fibers 1400. In some embodiments, the fibers 1300 are formed of a different material from the fibers 1300.

In general, the fibers 1300 and 1400 can have any desired cross-sectional shape, such as a circular, oval, triangular, rectangular, square or trapezoid. In some embodiments, the maximum cross-sectional dimension of the fibers 1300 and/or fibers 1400 is at least 5 (e.g., at least 10, at least 20, at least 50, at least 100, at least 200, at least 500) μm and/or at most 1000 (e.g., at most 500, at most 200, at most 100, at most 50, at most 20, at most 10, at most 5) μm.

Generally, the walls 1305 and 1405 can have any appropriate thickness. In some embodiments, the thickness of the walls 1305 and/or the walls 1405 is at least 1 (e.g., at least 2, at least 3, at least 4) μm and/or at most 5 (e.g., at most 4, at most 3, at most 2) μm.

In general, the dimensions of the fabric 1100 are determined based on the size of the defect area to be repaired. In certain embodiments, the fabric 1100 has a length of at least 1 (e.g., at least 2, at least 3, at least 4, at least 5, at least 6, at least 7, at least 8, at least 9) meter(s) (m) and/or at most 10 (e.g., at most 9, at most 8, at most 7, at most 6, at most 5, at most 4, at most 3, at most 2) m. In certain embodiments, the fabric 1100 has a width of at least 5 (e.g., at least 10, at least 15, at least 20, at least 25, at least 30, at least 35, at least 40, at least 45) cm and/or at most 50 (e.g., at most 45, at most 40, at most 35, at most 30, at most 25, at most 20, at most 15, at most 10) cm. In certain embodiments, the fabric 1100 has a thickness of at least 200 (e.g., at least 300, at least 400) μm and/or at most 500 (e.g., at most 400, at most 300) μm. Typically, the length of the fibers 1300 and/or fibers 1400 is the same as the length of the fabric 1100.

Examples of the matrix former 1310 include a polymer such as epoxy, vinylester, and/or polyurethane. Examples of the hardening agent 1410 include a polymercaptan, a polyamide, an amidoamine, an aliphatic amine, a cycloaliphatic amine, an aromatic amine, and/or a phenalkamine.

Without wishing to be bound by theory, the hardening agent 1410 causes permanent networking among the polymer chains of the matrix former 1310 resulting in curing (see discussion below).

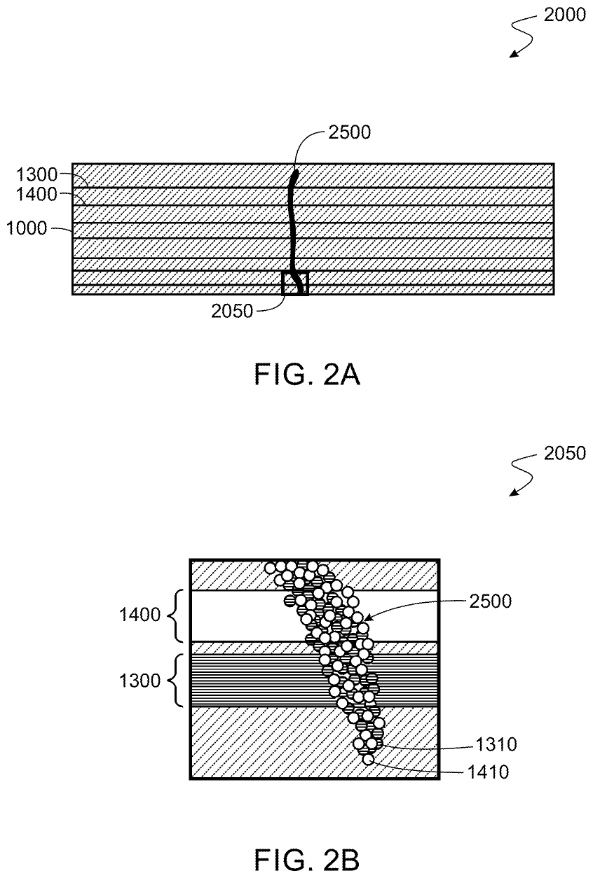

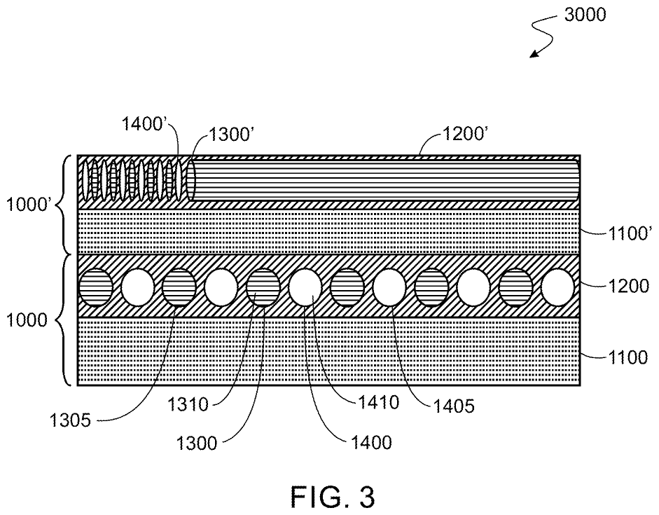

FIG. 2A depicts a plan view 2000 of the composite wrap 1000 with a crack 2500 in the matrix 1200 and FIG. 2B depicts an expanded view of a portion 2050 of the composite wrap 1000 and the crack 2500. The crack 2500 causes one or more fibers 1300 and one or more fibers 1400 to rupture and release the matrix former 1310 and the hardening agent 1410, respectively. The matrix former 1310 and the hardening agent 1410 at least partially fill the crack 2500 and form a solid matrix within the crack 2500, thereby closing the crack 2500. The fibers 1300 and fibers 1400 are arranged in an alternating fashion to ensure that the matrix former 1310 and hardening agent 1410 are adjacent to one another and can react to repair the crack 2500.

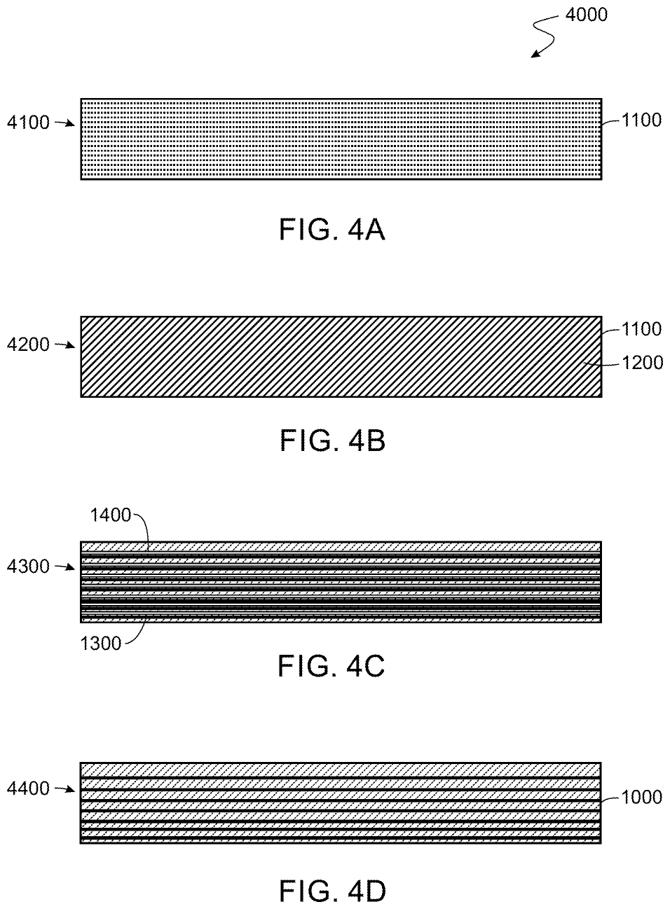

FIG. 3 depicts an article 3000 that includes the composite wrap 1000 and a composite wrap 1000′ disposed atop the composite wrap 1000. The composite wrap 1000′ includes the same components as the composite wrap 1000 with corresponding features having the same reference number followed by the symbol ′. However, the fibers in the composite wrap 1000′ are oriented at angle relative to the fibers in the composite wrap 1000. In certain embodiments, the plurality of fibers 1300′ and 1400′ are oriented at angle of at least 2° (e.g., at least 5°, at least 10°, at least 20°, at least 30°, at least 40°, at least 50°, at least 60°, at least 70°, at least 80°, at least 90°, at least 100°, at least 110°, at least 120°, at least 130°, at least 140°, at least 144°, at least 150°, at least 160°, at least 170) and/or at most 178° (e.g., at most 170°, at most 160°, at most 150°, at most 144°, at most 140°, at most 130°, at most 120°, at most 110°, at most 100°, at most 90°, at most 80°, at most 70°, at most 60°, at most 50°, at most 40°, at most 30°, at most 20°, at most 10°, at most 5°) relative to the plurality of fibers 1300 and 1400. In certain embodiments, the plurality of fibers 1300′ and 1400′ are approximately perpendicular to the plurality of fibers 1300 and 1400. The article 3000 can be used in a composite wrap repair of a defect section of a pipe (see discussion below). Without wishing to be bound by theory, it is believed that orienting the composite wrap 1000′ at an angle relative to the composite wrap 1000 allows the article 3000 to better respond to stress applied to the article 3000 and rupture the fibers 1300, 1400 and/or the fibers 1300′ and 1400′ when appropriate, regardless of the direction of the stress.

In certain embodiments, the thickness of the matrix 1200 is at least 1 (e.g., at least 2, at least 3, at least 4, at least 5, at least 6, at least 7, at least 8, at least 9) μm and/or at most 10 μm (e.g., at most 9, at most 8, at most 7, at most 6, at most 5, at most 4, at most 3, at most 2).

### Methods of Making and Using Self-Healing Composite Wraps

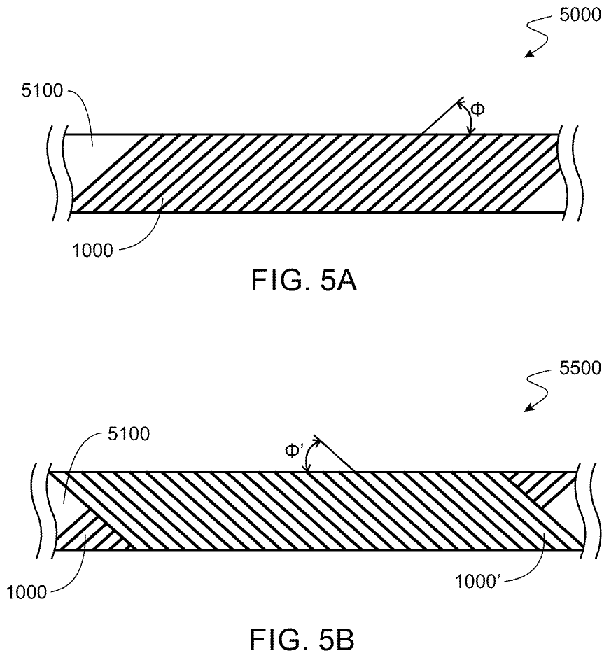

FIGS. 4A-4D depict schematic views of articles prepared after steps in a method 4000 for producing the composite wrap 1000. FIG. 4A depicts an article 4100 that is the fabric 1100. FIG. 4B depicts an article 4200 that is a first portion of the matrix 1200 disposed on the article 4100. FIG. 4C depicts an article 4300 that is the fibers 1300 and 1400 disposed on the article 4200. FIG. 4D depicts an article 4400 in which a second portion of the matrix 1200 is disposed atop the article 4300 to form the composite wrap 1000. The process for disposing the first and second portions of the matrix 1200 to provide the articles 4200 and 4400 includes disposing both a matrix former (e.g., an epoxy) and hardening agent that form the matrix 1200.

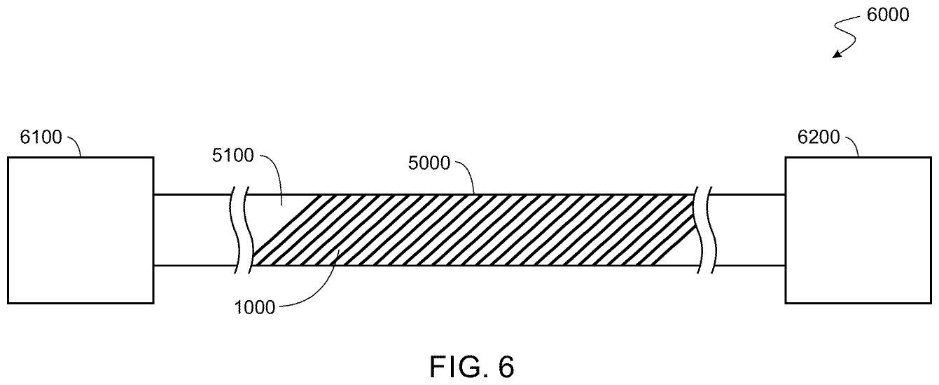

FIG. 5A depicts a schematic of a repaired pipe 5000 that includes the composite wrap 1000 wrapped around a pipe 5100 at an angle of p relative to the longitudinal direction of the pipe. In some embodiments, the composite wrap 1000 is wrapped at an angle φ of at least 10 (e.g., at least 2°, at least 3°, at least 4°, at least 5°, at least 10°, at least 15°, at least 20°, at least 25°, at least 30°, at least 35°, at least 40°, at least 45°, at least 50°, at least 55°, at least 60°, at least 65°, at least 70°, at least 75°, at least 80°, at least 85°) and/or at most 89° (e.g., at most 85°, at most 80°, at most 75°, at most 70°, at most 65°, at most 60°, at most 55°, at most 50°, at most 45°, at most 40°, at most 35°, at most 30°, at most 25°, at most 20°, at most 15°, at most 10°, at most 5°, at most 4°, at most 3°, at most 2°) relative to the pipe. Without wishing to be bound by theory, it is believed that the angle φ can be selected based on the type of stress. As an example, in the presence of axial stress, a relatively small angle (e.g., at least 10) is desired. As another example, in the presence of hoop stress, a relatively large angle (e.g., at most 89°) is desired. In some embodiments, the composite wrap 1000 is wrapped at an angle φ of from 45° to 65° (e.g., from 50° to 60°, from 53° to 57°, 55°) relative to the pipe. Without wishing to be bound by theory, it is believed that an angle of 55° can provide a balance of both axial and hoop loading strength.

FIG. 5B depicts a schematic of a repaired pipe 5500 that includes the components of the repaired pipe 5000 as well as the composite wrap 1000′ wrapped around the pipe 5100 and the composite wrap 1000 at an angle of φ′. In some embodiments, the composite wrap 1000′ is wrapped at an angle φ′ of at least −89° (e.g., at least −85°, at least −80°, at least −75°, at least −70°, at least −65°, at least −60°, at least −55°, at least −50°, at least −45°, at least −40°, at least −35°, at least −30°, at least −25°, at least −20°, at least −15°, at least −10°, at least −5°, at least −4°, at least −3°, at least −2°) and/or at most −1° (e.g., at most −2°, at most −3°, at most −4°, at most −5°, at most −10°, at most −15°, at most −20°, at most −25°, at most −30°, at most −35°, at most −40°, at most −45°, at most −50°, at most −55°, at most −60°, at most −65°, at most −70°, at most −75°, at most −80°, at most −85°) relative to the pipe. In some embodiments, the composite wrap 1000′ is wrapped at an angle φ′ of −55° relative to the pipe. The repaired pipes 5000 and 5500 can include additional layers of the composite wrap 1000 and/or 1000′.

FIG. 6 depicts a schematic of an oil and gas system 6000. The system includes a first component 6100 and a second component 6200. The repaired pipe 5000 can transport a fluid (e.g., oil, gas, water) from the first component 6100 to the second component 6200. In some embodiments, the first component 6100 is an oil and gas well and the second component 6200 is an oil and gas processing facility, an oil and gas storage facility or a power plant. In some embodiments, the first component 6100 is an oil and gas processing facility and the second component 6200 is an oil and gas storage facility or a power plant. In some embodiments, the first component 6100 is an oil and gas storage facility and the second component is an oil and gas processing facility or a power plant. In some embodiments, the oil and gas system 6000 is an oil and gas well, an oil and gas processing facility, an oil and gas storage facility or a power plant and the first component 6100, the second component 6200 and the repaired pipe 5000 are internal components in the oil and gas system 6000. The oil and gas system 6000 can be onshore or offshore. While the oil and gas system 6000 is depicted with the repaired pipe 5000, the oil and gas system 6000 can include the repaired pipe 5500 rather than the repaired pipe 5000. The repaired pipes 5000 and 5500 can include additional layers of the composite wrap 1000 and/or 1000′.

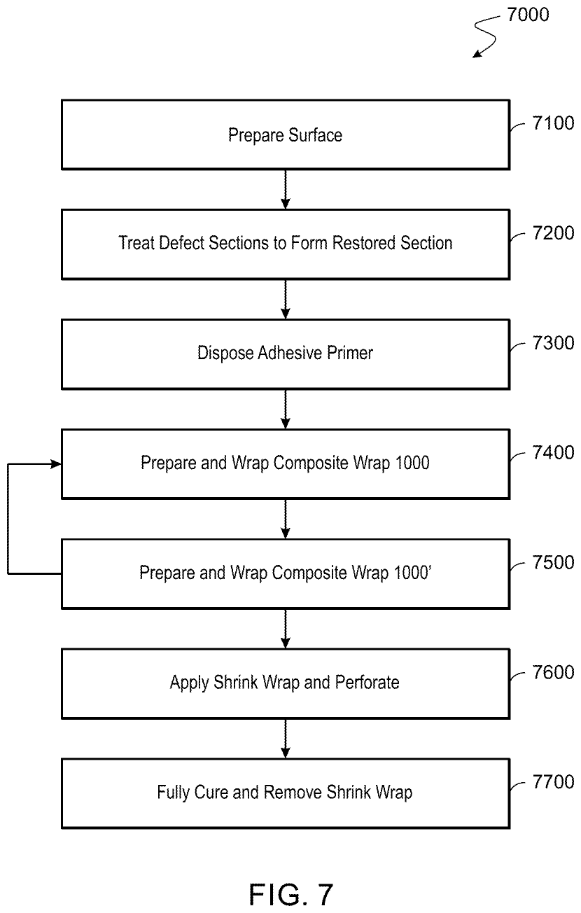

FIG. 7 depicts a flowchart for a method 7000 of repairing a defect section of a pipe using a composite article disclosed herein.
In step 7100, the surface of the pipe is prepared. The step 7100 generally includes removing paint, rust and/or grime using abrasive or grit blasting or sandpaper. Typically, the surface of the pipe should be dry and free of grease after the step 7100.
In step 7200, one or more defect sections of the surface of the pipe are treated. For example, the step 7200 can include restoring pitted surfaces of a defect section. This can be achieved, for example, using a high compressive-strength, load transferring filler material, such as a putty filler, to fill voids and level the defect section. Alternatively or additionally, the step 5200 can include tapering uneven welds and/or misaligned pipes by grinding or brushing the surface and then adding filler. Examples of the filler material include epoxy and vinylester. The step 7200 converts the defect section to a restored section of the surface of the pipe.
In step 7300, an adhesive primer is disposed onto the restored section of the surface of the pipe. The adhesive primer is usually a low viscosity polymeric primer, such as an epoxy or vinylester, which cures to a semi-rigid state, to provide bonding and load transfer. A tool, such as a slotted hand trowel or paintbrush can be used to dispose the adhesive primer onto the restored section of the surface of the pipe.
In step 7400, the composite wrap 1000 is wrapped on the restored section of the surface of the pipe. The composite wrap 1000 is wrapped at an angle (see discussion above). Prior to wrapping the composite wrap 1000 around the restored section of the pipe, the composite wrap 1000 can be prepared as depicted in the method 4000. In certain embodiments, the composite wrap 1000 is prepared immediately prior to disposing the composite wrap 1000 on the restored section.
In step 7500, the composite wrap 1000′ is wrapped on the restored section of the surface of the pipe (see discussion above). Prior to wrapping the composite wrap 1000′ around the restored section of the pipe, the composite wrap 1000′ can be prepared as depicted in the method 4000. In certain embodiments, the composite wrap 1000′ is prepared immediately prior to disposing the composite wrap 1000′ on the restored section.

The steps 7400 and 7500 are repeated until a desired number of layers is reached. In certain embodiments, the desired number of layers is at least 2 (e.g., at least 3, at least 4, at least 10, at least 20, at least 30, at least 40, at least 50, at least 60, at least 70, at least 80, at least 90) and/or at most 100 (e.g., at most 90, at most 80, at most 70, at most 60, at most 50, at most 40, at most 30, at most 20, at most 10).
In step 7600, a shirk wrap is applied atop the composite wrap layers. The shirk wrap is perforated to allow degassing and the release of excess matrix former (resin) and hardening agent. In step 7700, the system is heated and allowed to cure, after which the perforated shrink wrap is removed. In some embodiments, the system is allowed to cure for at least 24 (e.g., at least 30, at least 36, at least 42, at least 48, at least 60, at least 72) hours. Without wishing to be bound by theory, it is believed that the curing temperature depends on the matrix former (resin) and hardening agent. In some embodiments, the system is cured at a temperature of at least 50 (e.g., a least 100, at least 150) ° C. and/or at most 200 (e.g., at most 150, at most 100) ° C. In some embodiments, the system is cured at atmospheric pressure. In some embodiments, the system is cured using a vacuum to assist in degassing and bubble removal. In some embodiments, the system is cured in an autoclave at a temperature of 100-1000 psi. In some embodiments, the system is cured at ambient temperature and/or pressure.

### Other Embodiments

While certain embodiments have been disclosed above, the disclosure is not limited to such embodiments.

As an example, while embodiments have been disclosed that include disposing the composite wrap 1000′ on the composite wrap 1000, such that the plurality of fibers 1300′ and 1400′ of the composite wrap 1000′ are approximately perpendicular to the plurality of fibers 1300 and 1400 of the composite wrap 1000, the disclosure is not limited to such embodiments. For example, the successive layers of the composite wrap 1000 and 1000′ can be disposed atop one another such that the plurality of fibers 1300′ and 1400′ of the composite wrap 1000′ are randomly oriented relative to the plurality of fibers 1300 and 1400 of the adjacent the composite wrap 1000.

As another example, while embodiments have been disclosed that include forming a matrix in a crack to seal the crack, the disclosure is not limited to such embodiments. The systems and methods can be used to repair any defect in a composite wrap. In certain embodiments, the systems and methods can repair delamination in a composite wrap.

As a further example, while embodiments, have been disclosed that include repairing a defect in a metal pipe, the disclosure is not limited to such embodiments. In some embodiments, the pipe is a composite or nonmetallic pipe, such as a FRP (fiber reinforced pipe), a TCP (thermoplastics composite pipe), a RTR (Reinforced Thermoset Resin) pipe, a RTP (Reinforced Thermoplastics Polymer) pipe, a ceramic pipe, or a plastic pipe (e.g., PVC).

As an additional example, while embodiments have been disclosed that include repairing a pipe in an oil and gas system, the disclosure is not limited to such embodiments. In certain embodiments, the pipe is a water line, a sewer line, a chemical line, a component in a pressure vessel. In certain embodiments, the pipe is a component in process equipment.

What is claimed:

1. An article, comprising:
a first composite wrap, comprising:
a fabric that supports a matrix comprising a plurality of first fibers and a plurality of second fibers,
wherein:
the plurality of first fibers and the plurality of second fibers are arranged parallel to one another and in an alternating fashion;
the first fibers comprise an inner space comprising a matrix former;
the second fibers comprise an inner space comprising a hardening agent; and
the matrix former and hardening agent are configured to form a solid matrix upon contact.

2. The article of claim 1, further comprising:
a second composite wrap atop the first composite wrap,
wherein:
the second composite wrap comprises a fabric that supports a matrix comprising a plurality of third fibers and a plurality of fourth fibers;
the plurality of third fibers and the plurality of the fourth fibers are arranged parallel to one another and in an alternating fashion;
the third fibers comprise an inner space comprising the matrix former; and
the fourth fibers comprise an inner space comprising the hardening agent.

3. The article of claim 2, wherein the third and fourth fibers are oriented at an angle of from 2° to 178° relative to the first and second fibers.

4. The article of claim 1, wherein a thickness of the matrix of the first composite wrap is from 1 μm to 10 μm.

5. The article of claim 1, wherein at least one of the following holds:
the first and second fibers have a maximum cross-sectional dimension of 5 μm to 1000 μm; and
the first and second fibers have a wall thickness of from 1 μm to 5 μm.

6. The article of claim 1, wherein the first and second fibers comprise a member selected from the group consisting of polyester, polyurethane, polyvinylacetate, polysulphone (PSF), polyethersulphone (PES), polyacrylonitrile (PAN), polyvinyl alcohol, and/or polyvinylidene fluoride (PVDF).

7. The article of claim 1, wherein the matrix former comprises a member selected from the group consisting of epoxy, vinylester, and polyurethane.

8. The article of claim 1, wherein the hardening agent comprises a member selected from the group consisting of a polymercaptan, a polyamide, an amidoamine, an aliphatic amine, a cycloaliphatic amine, an aromatic amine, and a phenalkamine.

9. A system comprising:
a pipe; and
the article of claim 1 wrapped around a portion of the pipe.

10. The system of claim 9, wherein the article is wrapped is wrapped at an angle of 1° to 89° relative a longitudinal direction of the pipe.

11. The system of claim 9, wherein the pipe is a component of a system selected from the group consisting of an oil and gas production system, and oil and gas processing system, an oil and gas storage system, and a power plant.

12. A method, comprising:
applying a first composite wrap on a restored section of a pipe, wherein:
the first composite wrap comprises:
a fabric that supports a matrix comprising a plurality of first fibers and a plurality of second fibers,
wherein:
the plurality of first fibers and the plurality of second fibers are arranged parallel to one another and in an alternating fashion;
the first fibers comprise an inner space comprising a matrix former;
the second fibers comprise an inner space comprising a hardening agent; and
the matrix former and hardening agent are configured to form a solid matrix upon contact.

13. The method of claim 12, further comprising:
applying a second composite wrap atop the first composite wrap, wherein:
the second composite wrap comprises a fabric that supports a matrix comprising a plurality of third fibers and a plurality of fourth fibers;
the plurality of third fibers and the plurality of the fourth fibers are arranged parallel to one another and in an alternating fashion;
the third fibers comprise an inner space comprising the matrix former; and
the fourth fibers comprise an inner space comprising the hardening agent.

14. The method of claim 13, wherein the third and fourth fibers are oriented at an angle of from 2° to 178° relative to the first and second fibers.

15. The method of claim 12, wherein the first composite wrap is applied at an angle of from 1° to 89° relative to a longitudinal direction of the pipe.

16. The method of claim 12, further comprising:
rupturing at least a portion of the plurality of first and second fibers;
releasing at least a portion of the matrix former and hardening agent within the ruptured first and second fibers; and
reacting the matrix former and the hardening agent to form a solid matrix within a crack in the matrix.

17. The method of claim 12, further comprising, prior to applying the first composite wrap on the restored section of a metal pipe:
cleaning a defect section of the metal pipe;
disposing a filler material into the defect section to convert the defect section to a restored section; and
disposing an adhesive primer onto the restored section.

18. The method of claim 12, further comprising, after applying the first composite wrap on the restored section of a metal pipe:
applying a shrink wrap to the restored section;
perforating the shrink wrap;
allowing the matrix to cure; and
removing the shrink wrap.

19. The method of claim 12, further comprising, prior to applying the first composite wrap, forming the first composite wrap, comprising:
applying a first portion of the matrix on the fabric;
disposing the first and second fibers on the fabric; and
applying a second portion of the matrix on the fabric and the first and second fibers.

20. A method, comprising:
forming a composite wrap, comprising:
applying a first portion of a matrix on a fabric;
disposing a plurality of first and second fibers on the fabric; and
applying a second portion of the matrix on the fabric and plurality of first and second fibers,
wherein:
the plurality of first fibers and second fibers are arranged parallel to one another and in an alternating fashion;
the first fibers comprise an inner space comprising a matrix former;
the second fibers comprise an inner space comprising a hardening agent; and
the matrix former and hardening agent form a solid matrix upon contact.
